(19) United States
(12) Patent Application Publication
(10) Pub. No.: US 2021/0022329 A1
(43) Pub. Date: Jan. 28, 2021

(54) MODULAR HANDLE SYSTEMS FOR FISHING POLES

(71) Applicant: Jerry Lee Shedd, Moncks Corner, SC (US)

(72) Inventor: Jerry Lee Shedd, Moncks Corner, SC (US)

(21) Appl. No.: 16/916,890

(22) Filed: Jun. 30, 2020

Related U.S. Application Data
(60) Provisional application No. 63/016,029, filed on Apr. 27, 2020.
(60) Provisional application No. 62/879,519, filed on Jul. 28, 2019.

(51) Int. Cl. A01K 87/02; A01K 87/08

(52) U.S. Cl. CPC A01K 87/02; A01K 87/08

(57) ABSTRACT

A quick release, modular handle system for fishing rods includes a component stop and locking nut that permit removal and repair or replacement of handle components from a rod without cutting or gluing.

### CROSS-REFERENCE TO RELATED APPLICATIONS

This utility patent application claims benefit of U.S. Provisional Patent Application Ser. No. 62/879,519, filed in the United States Patent and Trademark Office on Jul. 28, 2019, and benefit of U.S. Provisional Patent Application Ser. No. 63/016,029, filed in the United States Patent and Trademark Office on Apr. 27, 2020, both of which are incorporated herein by reference in their entireties.

### BACKGROUND OF THE DISCLOSURE

Fishing rod handles and related components wear and deteriorate over time and with repeated use, or situations arise when a fisherman wishes to customize a fishing rod with a different handle. A drawback to known fishing rods is that handle components are fixed or bonded to an end of a pole. This conventional arrangement prevents handle replacement or requires extensive repair and replacement procedures to change a handle whether it is worn or broken or simply when the fisherman desires a different handle design.

What is needed in the fishing industry is a system that will permit removal and repair or replacement and reinstallation of handle components on a rod without cutting or adhesives.

### BRIEF SUMMARY OF THE DISCLOSURE

The present disclosure is directed in general to fishing rod handle systems that permit repair or replacement of fishing rod components without tools or adhesives. The fishing rod handle systems are simple to make, easy to use, and offer greater selections to consumers to accommodate personal preferences and customization with respect to materials, color, styles, and overall handle configurations.

In an exemplary embodiment, a modular fishing rod and reel system may include a rod having a proximal end and a distal end with an aperture formed in the proximal end. A stop mechanism may be located on the rod between the proximal end and the distal end, and a reel seat with a first cavity may receive the rod in the first cavity. A handle may be included with a second cavity, and the rod can be inserted into or through the second cavity. A locking nut constructed for connection in the aperture can be used to secure the handle against the reel seat and the reel seat against the stop mechanism.

Furthermore, the stop mechanism in the foregoing example may be unitarily formed with the rod and may have a non-circularly shaped opening. The rod may be tapered and insertable through the opening until surface areas of the tapered rod press-fit against the non-circular opening. Still further, the rod also may have a non-circularly shaped surface and may include edges, tracks, teeth, and/or star-shaped ridges to mate with complementarily shaped apertures in other handle components. A locking cap may be positioned between the stop mechanism and the distal end. More particularly, a locator cap may be located between the stop mechanism and the distal end, and the locking cap may be located between the distal end and the locator cap, such that the locator cap and the locking nut cooperate with each other to secure the handle against the reel seat and the reel seat against the stop mechanism.

In a further embodiment according to the disclosure, a modular fishing rod and reel system may include a rod having a proximal end and a distal end, an aperture being formed within the proximal end; a stop mechanism formed on the rod between the proximal end and the distal end; a locking cap disposed between the stop mechanism and the distal end; a reel seat having a first cavity formed therein, the rod being insertable through the first cavity; a handle having a second cavity formed therein, the rod being insertable through the second cavity; and a locking nut configured for connection in the aperture to secure the handle against the reel seat and the reel seat against the stop mechanism.

The stop mechanism of the modular fishing rod and reel system may have a non-circular shaped opening formed therethrough, and the rod may be tapered and insertable through the opening until the tapered rod press-fits against the non-circular opening.

The modular fishing rod and reel system may further include a locator cap positioned between the stop mechanism and the distal end. The locking cap may be located between the distal end and the locator cap, and the locator cap may cooperate with the locking nut to secure the handle against the reel seat and the reel seat against the stop mechanism.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 shows a side elevational view of one embodiment of an assembled fishing rod handle system according to one aspect of the disclosure;

FIG. 2 shows a sectional view of the embodiment taken along lines II-II in FIG. 1;

FIG. 3 is an exploded view of the embodiment as in FIG. 1;

FIG. 4 is a more detailed exploded view of the embodiment as in FIGS. 1 and 3, particularly showing top and bottom end views, perspective views and a cross sectional view of certain components;

FIG. 5 is an elevational view of another embodiment of a fishing rod handle system according to another aspect of the disclosure;

FIG. 6 is an exploded view of the embodiment as in FIG. 5;

FIG. 7 is an elevational view of a further embodiment of a fishing rod handle system according to yet another aspect of the disclosure;

FIG. 8 is an exploded view of the embodiment as in FIG. 7; and

FIG. 9 shows for comparative purposes side-by-side, exploded, perspective views of the embodiments as in FIGS. 6 and 8.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Wherever the phrase “for example,” “such as,” “including,” and the like are used herein, the phrase “and without limitation” is understood to follow unless explicitly stated otherwise. Similarly, “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etcetera. Thus, for example, “a device having components a, b, and c” means that the device includes at least components a, b, and c. Similarly, the phrase: “a method involving steps a, b, and c” means that the method includes at least steps a, b, and c.

Where a list of alternative component terms is used, e.g., “a structure such as ‘a’, ‘c’, ‘d’ or the like”, or “a or b”, such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise”, “comprising”, and the like are to be construed in an inclusive sense as opposed to an exclusive or exhaustive sense; in the sense of “including, but not limited to”.

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

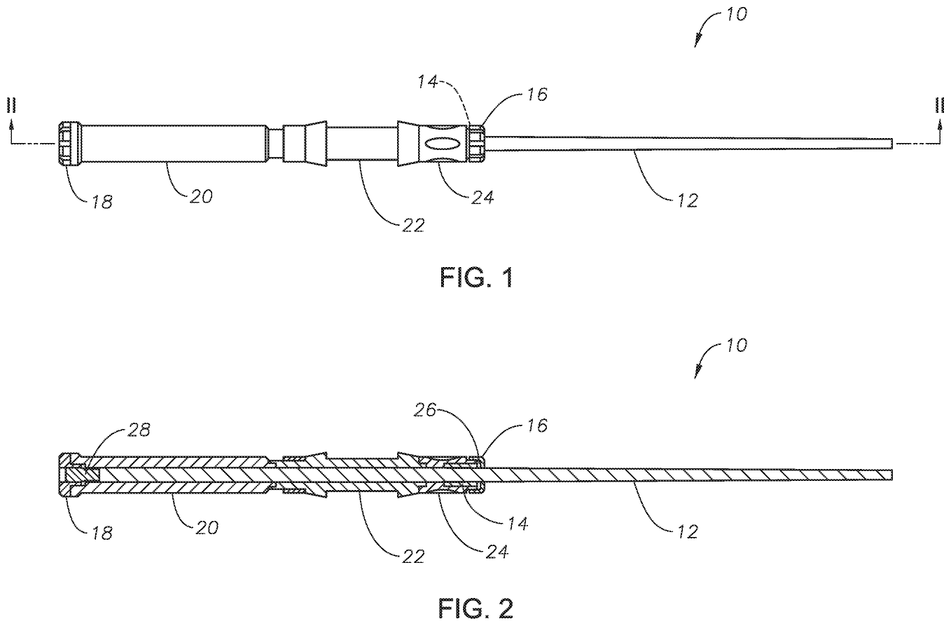

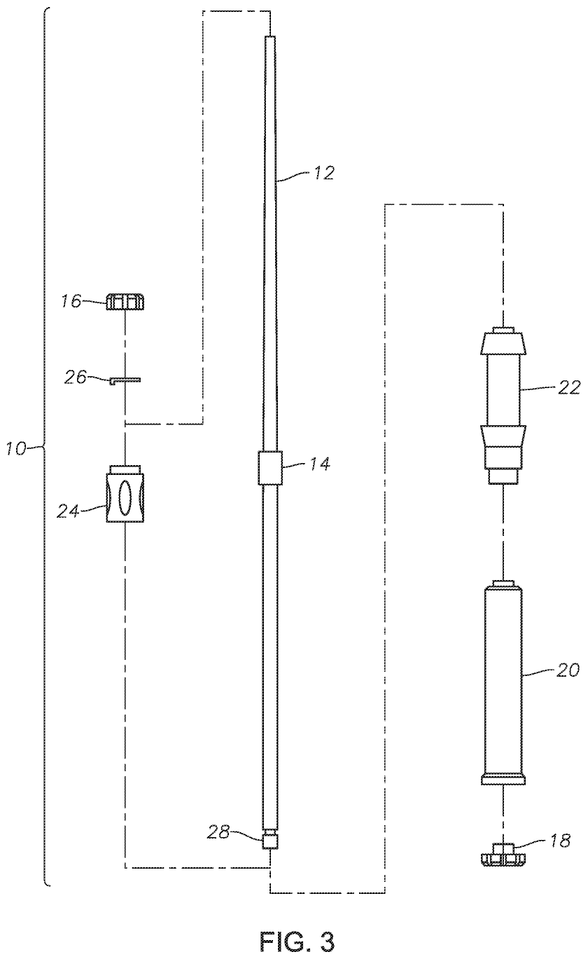

Turning now to FIG. 1, an assembled fishing rod handle system according to the disclosure is designated broadly by element number 10. The exemplary system 10 may include a blank or pole 12 to which a pole locator body 14 is affixed or connected. Here, a locking nut 16 is secured to the pole locator body 14, and a locking knob 18 is attached at a handle end of the pole 12. A handle 20, a reel seat assembly 22, and a nose piece 24 are secured between the locking nut 16 and the locking knob 18. In this example, the pole 12 may be made from fiberglass, wood, metal, or other strong, flexible materials suitable for fishing poles. The pole locator body 14 may be made from the same or similar material as the pole 12 and formed therewith as a unitary blank. Alternatively, the locator body 14 subsequently can be affixed to the pole 12 mechanically or with an adhesive as described in greater detail with respect to FIG. 3 below.

FIG. 2 shows a cross section of the embodiment of FIG. 1. Here, the upper locator body 14 is shown most clearly centering and aligning other components along the pole 12. When assembled as in FIG. 2, the locking nut 16 will capture and press against the upper locator body 14 while the locking knob 18 presses against a portion of the handle 20 to secure the components in place.

FIG. 3 is an exploded view of the fishing rod handle system 10 in which the pole locator body 14 is formed with or affixed to the pole 12. As shown, the locking nut 16 and a washer 26 slide over an end of the pole 12 above the body 14, and the nose piece 24 slides over an opposite end of the pole 12; i.e., from below the body 14. Following the nose piece 24, the reel seat assembly 22 and the handle 20 slide over the pole 12, and the locking knob 18 is screwed into a threaded locking stud 28 that has been fitted into a terminal end of the pole 12. In this example and as introduced above, the locking nut 16 is screwed onto or press fitted against the nose piece 24 to capture the pole locator body 14. Meanwhile, the locking knob 18 is screwed into the threaded locking stud 28 from the opposite direction such that the handle 20, the reel seat assembly 22, and the nose piece 24 are pressed together.

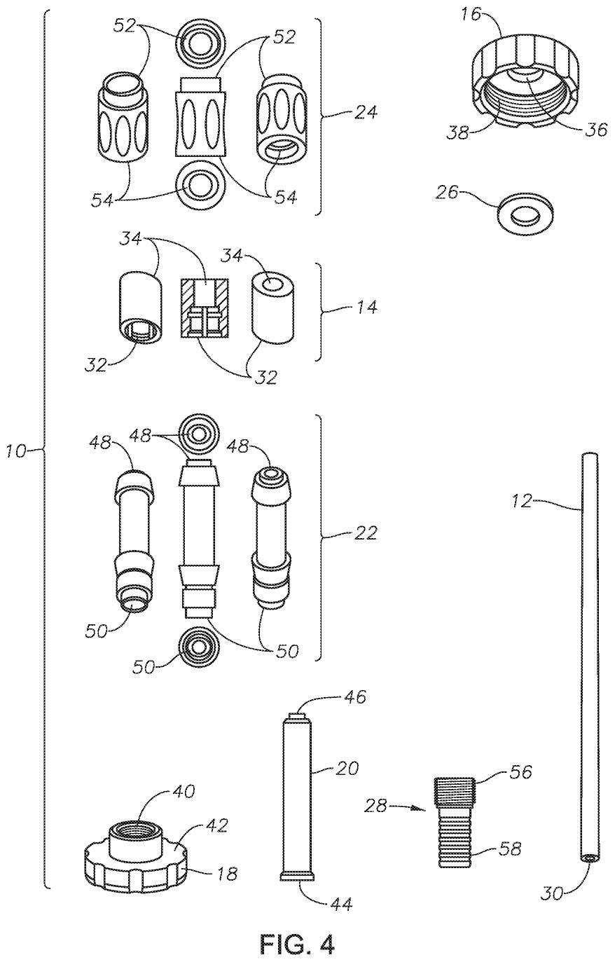

FIG. 4 shows the components of the fishing rod handle system 10 further separated for additional clarity and detail, although the components may not be shown to scale nor in precise order of assembly. Here, the pole 12 has an aperture end 30, and two perspective views and one cross sectional view of the pole locator body 14 show a first aperture end 32 and a second aperture end 34. The first aperture end 32 includes an epoxy pocket with gripper channels, and the second aperture end 34 may have an oval shape tapering toward the first aperture end 32 to limit a distance that the pole locator body 14 can slide along the pole 12. More specifically, the aperture end 30 of the pole 12 slides through the second aperture end 34 and out the first aperture end 32. Once the pole locator body 14 is in the desired position along the pole 12, it can be mechanically affixed or bonded to the pole 12. Next, the nose piece 24, which includes an upper aperture 52 (shown in perspective and top and bottom end views) and a lower aperture 54 (shown in perspective and top and bottom end views), slides over the pole 12. Like the pole locator body 14, the apertures 52, 54 of the nose piece 24 may have a non-round shape such as an oval shape to squeeze against the round, tapered surface, or circumference of the pole 12.

FIG. 4 shows, as introduced in FIG. 3, that the locking nut 16 follows the washer 26 on the pole 12. The locking nut 16 can be screwed against or snap-fitted near the upper aperture 52 of the nose piece 24, which has been positioned against or around the pole locator body 14 from the opposite direction. More specifically, the locking nut 16 may include an opening 36 through which the pole 12 may slide and may include a set of threads 38 to screw onto complementary threads of the nose piece 24.

As more particularly shown in FIG. 4, the reel seat 22 may include oval-shaped apertures 48, 50, through which the pole 12 slides, and an end of the reel seat 22 near the aperture 48 will seat against the pole locator body 14. Mated near the aperture 50 is a shoulder 46 of the handle 20. Here, the knob 18 may include a complementary shoulder 42 to press against an end 44 of the handle 20 though which an opening 30 in the pole 12 extends. The stud 28 may include a male threaded end 56 and a press-fit end 58. The end 58 may be press-fit into the opening 30, and a female threaded end 40 of the knob 18 may be attached to the threaded end of the stud 28. Although male and female threads have been described on certain components by way of example, these may be reversed to accommodate manufacturing requirements or user preferences. For instance, the threaded end 56 of the stud 28 may be configured with female threads, and the threaded end 40 of the knob 18 may be a male configuration.

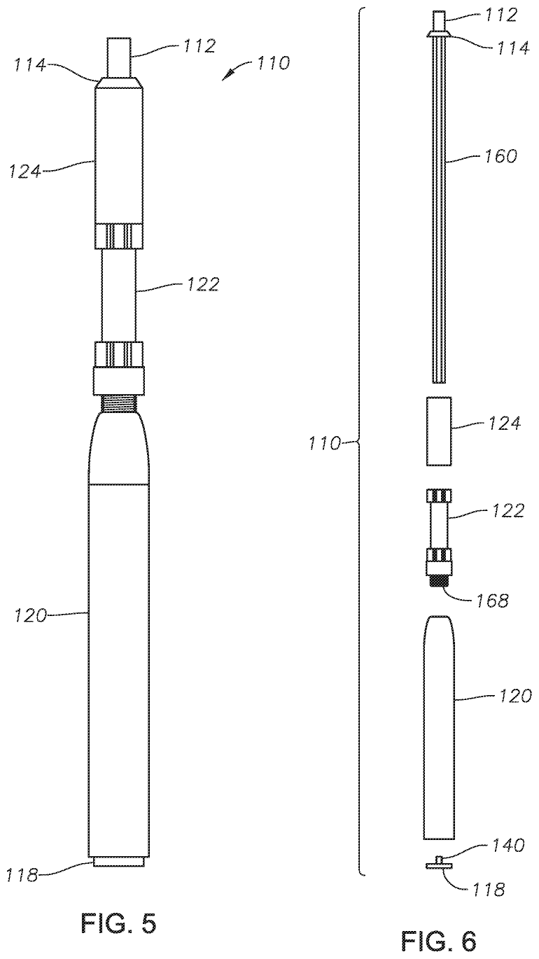

With reference now to FIGS. 5 and 6, another embodiment of a fishing rod handle system according to the disclosure is designated broadly by element number 110. The exemplary system 110 may include a blank or pole 112 to which a pole locator body 114 is affixed. The pole locator body 114 acts as a winding check to prevent the assembly components from moving past their desired stop point. Here, the pole 112 has a track 160 that may be star-shaped or grooved, which may be inserted into and through a nose piece or foregrip 124, a reel seat 122, and a rear grip 120. More particularly, a thread assembly 140 of a knob 118 may be screwed into a receptacle 168 of the reel seat 122 to secure the components into place against the pole locator body 114.

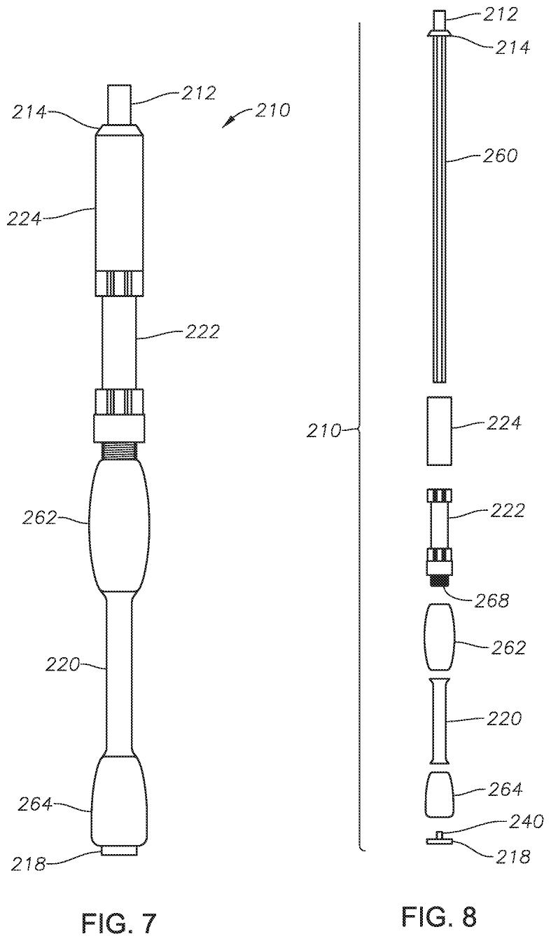

FIGS. 7 and 8 show another embodiment of a fishing rod handle system designated broadly by element number 210. The exemplary system 210 may include a blank or pole 212 to which a pole locator body 214 is affixed. The pole locator body 214 acts as a winding check to prevent the assembly components from moving past their desired stop point. Here, the pole 212 has a track 260 that may be star-shaped or grooved and inserted into and through a nose piece or foregrip 224, a reel seat 222, and a split rear grip or sleeve 220 having a forward grip 262 and a rear grip 264. More particularly, a thread assembly 240 of a knob 218 may be screwed into a receptacle 268 of the reel seat 222 to secure the components into place against the pole locator body 214.

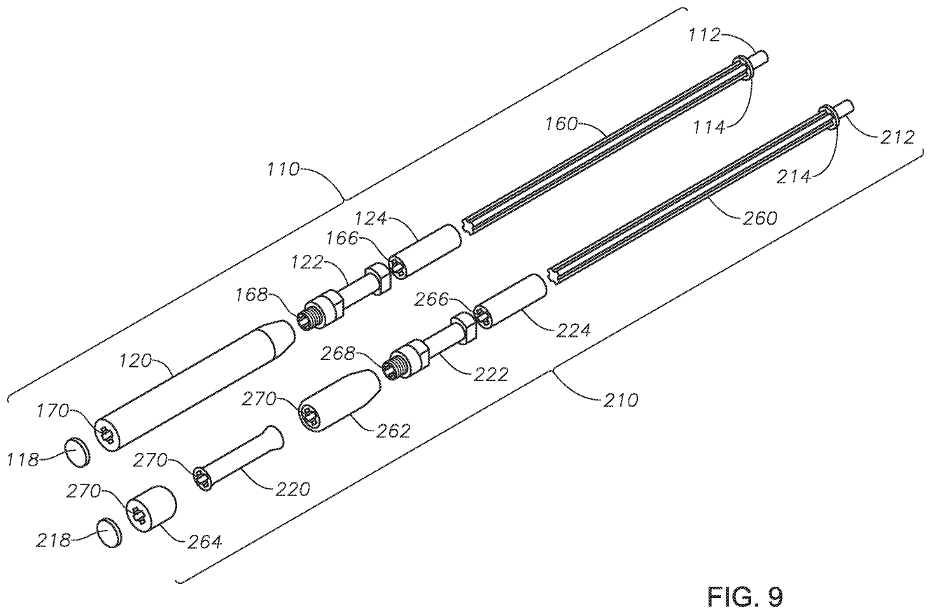

Turning to FIG. 9, the exemplary systems 110, 210 are shown exploded side-by-side for comparison. As above, each system 110, 210 contains respective poles 112, 212 to which pole locator bodies 114, 214 are affixed, and the poles 112, 212 each have tracks 160, 260 that are inserted into and through nose pieces 124, 224, reel seats 122, 222, and rear grips 120, 220. Thread assemblies 140, 240 of knobs 118, 218 are screwed into receptacles 168, 268 of the reel seats 122, 222 to secure the components into place against the locator bodies 114, 214.

FIG. 9 more particularly shows that the nose pieces 124, 224 have respective apertures 166, 266 and the grips 120, 220 have respective apertures 170, 270, all of which have complementary shapes to accommodate the star or groove shaped tracks 160, 260 of the respective poles 112, 212. For instance, the tracks 160, 260 may have four or more teeth and the apertures 166, 266, 170, 270 may have an inverse design to mate with the teeth. Wall thickness and materials of the respective components can be selected to achieve strength and durability according to the category of fishing.

In any of the foregoing embodiments, the knobs 18, 118, 218 can be removed or unscrewed to slide all components from the poles 12, 112, 212 in order to change or repair one or more of the components without having to cut or break the poles 12, 112, 212 or any component.

By way of example and not of limitation, embodiments of the disclosure may include:

### EMBODIMENT 1

A modular fishing rod and reel system, comprising a rod having a proximal end and a distal end, an aperture being formed within the proximal end; a stop mechanism disposed on the rod between the proximal end and the distal end; a reel seat having a first cavity formed therein, the rod being insertable through the first cavity; a handle having a second cavity formed therein, the rod being insertable through the second cavity; and a locking nut configured for connection in the aperture to secure the handle against the reel seat and the reel seat against the stop mechanism.

### EMBODIMENT 2

The modular fishing rod and reel system as in Embodiment 1, wherein the stop mechanism is unitarily formed with the rod.

### EMBODIMENT 3

The modular fishing rod and reel system as in Embodiment 1, wherein the stop mechanism includes a non-circular opening formed therethrough, the rod being tapered and insertable through the opening until the tapered rod press-fits against the non-circular opening.

### EMBODIMENT 4

The modular fishing rod and reel system as in Embodiment 1, further comprising a locking cap disposed between the stop mechanism and the distal end.

### EMBODIMENT 5

The modular fishing rod and reel system as in Embodiment 1, further comprising a locator cap disposed between the stop mechanism and the distal end and a locking cap disposed between the distal end and the locator cap, the locator cap configured to cooperate with the locking nut to secure the handle against the reel seat and the reel seat against the stop mechanism.

### EMBODIMENT 6

The modular fishing rod and reel system as in Embodiment 1, wherein the rod has a non-circular surface.

### EMBODIMENT 7

The modular fishing rod and reel system as in Embodiment 1, wherein the rod includes ridges.

### EMBODIMENT 8

A modular fishing rod and reel system comprising a rod having a proximal end and a distal end, an aperture being formed within the proximal end; a stop mechanism formed on the rod between the proximal end and the distal end; a locking cap disposed between the stop mechanism and the distal end; a reel seat having a first cavity formed therein, the rod being insertable through the first cavity; a handle having a second cavity formed therein, the rod being insertable through the second cavity; and a locking nut configured for connection in the aperture to secure the handle against the reel seat and the reel seat against the stop mechanism.

### EMBODIMENT 9

The modular fishing rod and reel system as in Embodiment 8, wherein the stop mechanism includes a non-circular shaped opening formed therethrough, the rod being tapered and insertable through the opening until the tapered rod press-fits against the non-circular opening.

### EMBODIMENT 10

The modular fishing rod and reel system as in Embodiments 8 or 9, further comprising a locator cap disposed between the stop mechanism and the distal end, the locking cap disposed between the distal end and the locator cap, the locator cap configured to cooperate with the locking nut to secure the handle against the reel seat and the reel seat against the stop mechanism.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A modular fishing rod and reel system, comprising:
a rod having a proximal end and a distal end, an aperture being formed within the proximal end;
a stop mechanism disposed on the rod between the proximal end and the distal end;
a reel seat having a first cavity formed therein, the rod being insertable through the first cavity;
a handle having a second cavity formed therein, the rod being insertable through the second cavity; and
a locking nut configured for connection in the aperture to secure the handle against the reel seat and the reel seat against the stop mechanism.

2. The modular fishing rod and reel system as in claim 1, wherein the stop mechanism is unitarily formed with the rod.

3. The modular fishing rod and reel system as in claim 1, wherein the stop mechanism includes a non-circular opening formed therethrough, the rod being tapered and insertable through the opening until the tapered rod press-fits against the non-circular opening.

4. The modular fishing rod and reel system as in claim 1, further comprising a locking cap disposed between the stop mechanism and the distal end.

5. The modular fishing rod and reel system as in claim 1, further comprising a locator cap disposed between the stop mechanism and the distal end and a locking cap disposed between the distal end and the locator cap, the locator cap configured to cooperate with the locking nut to secure the handle against the reel seat and the reel seat against the stop mechanism.

6. The modular fishing rod and reel system as in claim 1, wherein the rod has a non-circular surface.

7. The modular fishing rod and reel system as in claim 1, wherein the rod includes ridges.

8. A modular fishing rod and reel system, comprising:
a rod having a proximal end and a distal end, an aperture being formed within the proximal end;
a stop mechanism formed on the rod between the proximal end and the distal end;
a locking cap disposed between the stop mechanism and the distal end;
a reel seat having a first cavity formed therein, the rod being insertable through the first cavity;
a handle having a second cavity formed therein, the rod being insertable through the second cavity; and
a locking nut configured for connection in the aperture to secure the handle against the reel seat and the reel seat against the stop mechanism.

9. The modular fishing rod and reel system as in claim 8, wherein the stop mechanism includes a non-circular shaped opening formed therethrough, the rod being tapered and insertable through the opening until the tapered rod press-fits against the non-circular opening.

10. The modular fishing rod and reel system as in claim 8, further comprising a locator cap disposed between the stop mechanism and the distal end, the locking cap disposed between the distal end and the locator cap, the locator cap configured to cooperate with the locking nut to secure the handle against the reel seat and the reel seat against the stop mechanism.
